(19) United States
(12) Patent Application Publication
(10) Pub. No.: US 2026/0258891 A1
(43) Pub. Date: Sep. 3, 2026

(54) STUB DOWN CONDUIT ASSEMBLY

(71) Applicant: ERICO International Corporation, Solon, OH (US)

(72) Inventors: Scott Ernest Anderson, Garrettsville, OH (US); Daniel A. Kozlowski, Stow, OH (US)

(21) Appl. No.: 19/554,264

(22) Filed: Mar. 2, 2026

Related U.S. Application Data
(60) Provisional application No. 63/857,105, filed on Aug. 4, 2025.
(60) Provisional application No. 63/765,861, filed on Mar. 3, 2025.

(51) Int. Cl. F16L 37/091; F16L 5/00

(52) U.S. Cl. CPC F16L 37/0915; F16L 5/00

(57) ABSTRACT

A conduit system for passing through concrete sections can include a conduit body defining an internal passage extending from an entrance to an exit. A clip received within the conduit body can include a clip body with a central opening to receive tubing. Grips can extend from the clip body in a first axial direction, and locking arms with fingers to engage the tubing can extend in a second axial direction. The grips can be movable to flex the locking arms and move the fingers outwardly to release the tubing.

### CROSS-REFERENCE TO RELATED APPLICATION

This application claims priority to U.S. Provisional Application No. 63/857,105, filed August 4, 2025, and U.S. Provisional Application No. 63/765,861, filed March 3, 2025, which is hereby incorporated by reference in its entirety.

### BACKGROUND

In-deck conduits can provide passages within concrete decks for electrical wiring or other components. In some approaches, an in-deck conduit can be placed into position on a plywood mold and concrete can be poured around the conduit so that the in-deck conduit provides a passage within the concrete deck once the concrete has set.

### SUMMARY

According to one aspect of the present disclosure, a conduit system for passing through concrete sections is provided. The conduit system can include a conduit body defining an internal passage extending from an entrance at a deck end of the conduit body to an exit at a base end of the conduit body. The base end can include a mounting flange configured to secure the conduit body to a concrete form. The conduit system can include a first locking slot and a second locking slot formed in the conduit body adjacent the deck end. The first and second locking slots can extend from an exterior surface of the conduit body to the internal passage. The conduit system can include a clip received into the conduit body. The clip can include a clip body including a central opening configured to receive tubing along a tubing axis. The clip can include a first grip and a second grip extending in a first axial direction from the clip body. The clip can include a first locking arm and a second locking arm extending from the clip body in a second axial direction opposite the first axial direction. Each of the first and second locking arms can extend into the internal passage and can have a locking tab extending outwardly relative to the tubing axis and being received within the first or second locking slot to retain the clip relative to the conduit body. Each of the first and second locking arms can have a finger extending inwardly relative to the tubing axis to engage the tubing within the internal passage. The first and second grips can each extend outwardly relative to the tubing axis, to be movable relative to the clip body to move the first and second locking arms and thereby move the fingers outwardly relative to the tubing axis to release the tubing for movement along the tubing axis.

In some examples, the deck end of the conduit body may define pockets along the internal passage that receive the first and second locking arms of the clip.

In some examples, with the first and second locking arms in a flexed configuration, the fingers may be received within the pockets to provide clearance for movement of the tubing along the tubing axis within the internal passage.

In some examples, in an unflexed configuration, the first and second locking arms may angle towards one another, from the clip body to the fingers, to provide biased engagement of the fingers with the tubing.

In some examples, the tubing may be corrugated tubing, and the fingers may extend into corresponding grooves of the corrugated tubing to retain the corrugated tubing within the conduit body.

In some examples, the conduit body may include an internal ledge that abuts the clip body to provide a stop against over-insertion of the clip along the tubing axis.

In some examples, each of the first and second grips may include a flange portion that extends radially outwardly away from the clip body.

In some examples, the deck end of the conduit body may define notches that receive the flange portions of the first and second grips.

In some examples, the flange portions may be recessed into the notches to be flush with the conduit body at the entrance of the internal passage.

In some examples, the internal passage may extend in an insertion direction from the entrance toward the exit, and the entrance may include a tapered portion that narrows along the insertion direction.

According to another aspect of the present disclosure, a conduit system for passing through concrete sections is provided. The conduit system can include a conduit body having a deck end and a base end configured to be secured to a concrete form. The conduit body can define an internal passage that extends from an entrance at the deck end to an exit at the base end. The conduit system can include a clip that is receivable into the deck end to secure corrugated tubing within the conduit body. The clip can include a clip body configured to surround the corrugated tubing. The clip can include locking arms extending axially from the clip body. The locking arms can include locking tabs extending outwardly to retain the clip within the conduit body. The locking arms can include fingers located distal from the clip body. The fingers can form protrusions that extend radially inwardly to engage corrugated tubing received within the conduit body. The clip can include grips extending axially from the clip body in an opposite direction from the locking arms. The grips can protrude radially outwardly from the clip body and can be configured to be urged towards one another to move the fingers apart from each other, to release the corrugated tubing from the conduit body.

In some examples, the locking tabs may be beveled on a first side and squared on an opposing second side.

In some examples, the squared second side of the locking tabs may form a shoulder that abuts a surface of a corresponding locking slot of the conduit body to retain the clip within the conduit body.

In some examples, the conduit body may include locking slots that receive the locking tabs. The locking tabs may be configured to contact the conduit body at sides of the locking slots to define pivot points, about which locking arms pivot to move the fingers apart from each other when the grips are urged towards one another.

In some examples, the conduit body may include pockets along the internal passage. With the clip received into the deck end, the locking arms may be aligned to pivot into the pockets in response to the grips being urged towards one another, to move the fingers away from the corrugated tubing.

In some examples, the locking arms may angle inwardly towards one another, from the locking tabs to the fingers, to bias the fingers into engagement with the corrugated tubing.

According to yet another aspect of the present disclosure, a method of installing tubing in a conduit system is provided. The method can include providing a conduit body having an internal passage that extends from an entrance at a deck end to an exit at a base end. The conduit body can have locking slots formed adjacent the deck end. The internal passage can receive a clip, with locking arms of the clip extending from a clip body along the internal passage. Locking tabs on the locking arms can engage the locking slots. Fingers on the locking arms can extend inwardly into the internal passage. First and second grips of the clip can protrude outwardly from the clip body. The method can include inserting tubing into the internal passage through the entrance, so that the fingers resiliently engage an exterior surface of the tubing to retain the tubing within the conduit body. The method can include adjusting a position of the tubing within the internal passage by applying force to the first and second grips to move the fingers away from the tubing, moving the tubing axially to a new position relative to the clip, and after moving the tubing to the new position, releasing the force from the first and second grips so that the fingers are resiliently returned into engagement with the tubing to retain the tubing at the new position.

In some examples, the method may further include removing the tubing from the conduit body by applying the force as a compressive force to the first and second grips and withdrawing the tubing from the internal passage while the compressive force is being applied.

In some examples, the method may further include reinserting the tubing into the internal passage through the entrance after withdrawing the tubing.

In some examples, the method may further include replacing the tubing with a different tubing after withdrawing the tubing.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a top axonometric view of an in-deck conduit with a clip, according to one embodiment of the invention;

FIG. 2 is a bottom axonometric view of the in-deck conduit of FIG. 1;

FIG. 3 cross-sectional view taken along center plane III-III of the in-deck conduit of FIG. 1;

FIG. 4 is an axonometric view of the clip of FIG. 1;

FIG. 5 is an axonometric detail view of an entrance of the in-deck conduit of FIG. 1;

FIG. 6A is a side elevation detail view of the entrance of the in-deck conduit of FIG. 1, with the clip in a staged orientation;

FIG. 6B is a side elevation view of the entrance of the in-deck conduit of FIG. 1, with the clip in a locked orientation and securing a length of tubing;

FIG. 7 is a detail view of the entrance of in-deck conduit of FIG. 1 with the clip in the locked orientation;

FIG. 8A-8C are axonometric views of the in-deck conduit of FIG. 1, during an example installation with a threaded coupler;

FIG. 9 is an exploded view of an in-deck conduit with a clip, according to another embodiment fo the invention;

FIG. 10 is a side view of the clip of FIG. 9;

FIG. 11 is an axonometric view of the in-deck conduit with the clip in an installed configuration of FIG. 9;

FIG. 12 is a cross-sectional partial view of the in-deck conduit of FIG. 11 taken along lines XII-XII, with corrugated tubing installed;

FIG. 13 is an exploded view of an in-deck conduit with a first clip and a second clip, according to another embodiment fo the invention;

FIG. 14 is a front view of one of the clips of FIG. 13;

FIG. 15 is an axonometric view of the in-deck conduit of FIG. 13 with the clip in an installed configuration; and

FIG. 16 is a cross-sectional partial view of the in-deck conduit of FIG. 15 taken along lines XVI-XVI, with corrugated tubing installed.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

In different contexts, it may be useful to provide structures that can guide wiring or other components within (e.g., fully through a thickness of) a concrete deck after the concrete has been poured and set. For example, known stub (and other) conduits can be installed on a form for a deck so that concrete for the deck can be poured around the conduits. The conduits can thus provide a passage within the deck for use after the concrete has set and the form has been removed.

In some cases, it may be useful to secure tubing to a conduit. For example, a clip that is selectively coupled to the conduit can be used to engage the corrugations of electrical non-metallic tubing (ENT), to prevent the ENT from being inadvertently pulled out of engagement with the conduit. However, conventional designs for in-deck conduits do not provide an accessible and convenient means for securing or adjusting tubing relative to the conduit. Further, conventional conduits may tend to be removed from the concrete by removal of a form – or to be intended to be thus removed – which may lead to significant manual work in some cases, including to pry the conduit free or address unpredictable, non-uniform, and aesthetically disfavored recesses formed in the set concrete by removal of the conduit. Thus, there is a need in the art to provide conduits to better secure tubing relative to in-deck conduit until concrete has been poured and set, and to provide improved operations for continued installation once the concrete has set.

Embodiments of the invention can address these or other issues. For example, some embodiments can include a clip that is selectively coupled with a conduit to secure tubing received by the conduit (e.g., corrugated ENT or other tubing). For example, a clip can include one or more tabs configured to extend into a conduit to engage and secure the exterior profile of relevant tubing within the conduit. Some clips can thus provide improved accessibility for securing the tubing relative to the conduit during installation, as well as allowing adjustments thereafter. In some examples, internal profiles of a conduit can also help to provide a leak-proof seal, to ensure that poured concrete does not enter and plug the tubing and the conduit (e.g., with the tubing thus secured by a push-in or other clip, as generally noted above).

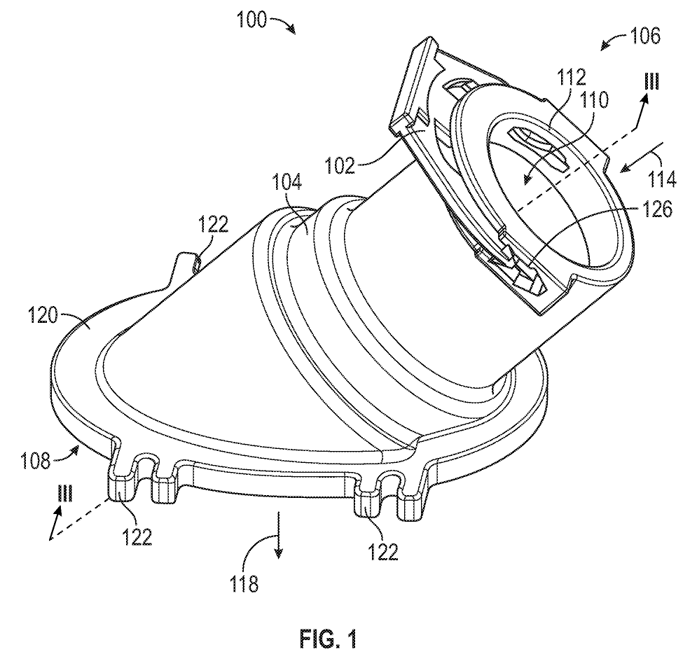

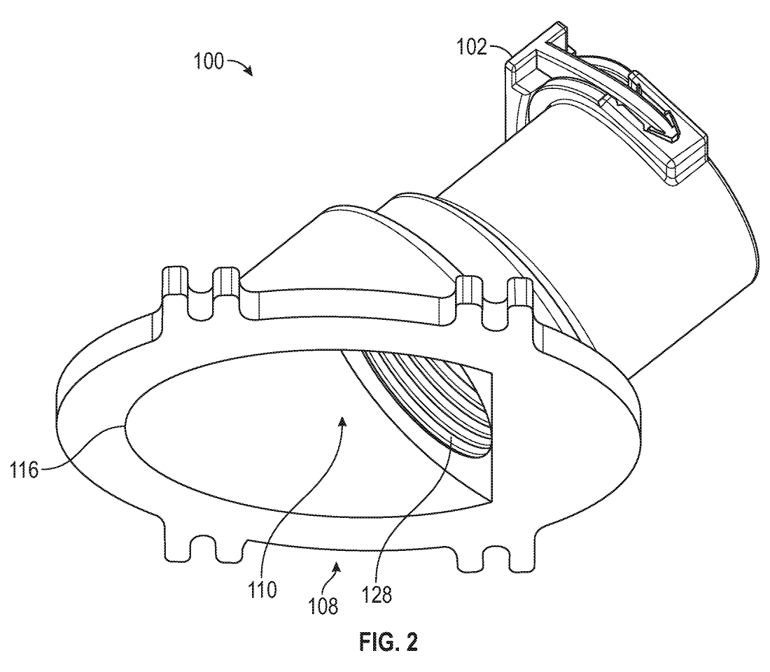

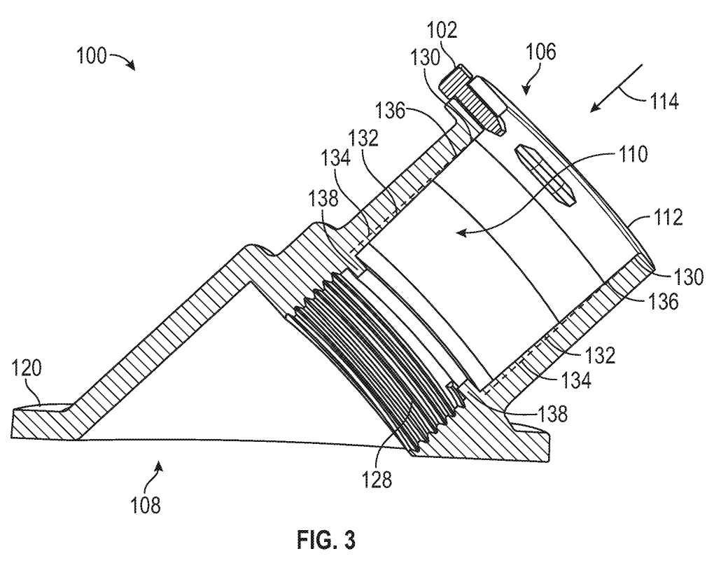

FIGS. 1 through 3 illustrate an in-deck conduit 100 with a clip 102. As further detailed below, the clip 102 is shown installed in a staged orientation in FIG. 1, and in a locked orientation in FIGS. 2 and 3. The in-deck conduit 100 has a body 104 that is cylindrical in shape, having a deck end 106 and a base end 108. An enclosed, internal passage 110 enclosed within the body 104 begins at an entrance 112 located proximate the deck end 106 and defines an entrance direction 114. The internal passage 110 extends from the entrance 112 through the body 104, and ends at an exit 116 (see FIG. 2) located proximate the base end 108 and defining an exit direction 118. The entrance direction 114 generally indicates a direction in which wiring can be guided into the body 104 of the conduit 100 and thereby through a poured concrete deck (not shown). Likewise, the exit direction 118 indicates how wiring can be guided out of the body 104 of the conduit 100 and thereby through a poured concrete deck (not shown). However, as used herein, “exit” and “entrance” are used for convenience of presentation and do not necessarily require that wiring or other components can only be threaded into or through a conduit in one direction – e.g., from entrance to exit. Generally, an “entrance direction” and an “exit direction” can be determined as a direction that is perpendicular to a plane defined by a cross-section of a passage at the relevant entrance or exit, respectively, or as a direction that is parallel to an axial direction of an entrance or exit region of an internal passage that is adjacent to or forms the relevant entrance or exit.

In different embodiments, the internal passage 110 defined by the in-deck conduit 100 can provide an angled or otherwise bent path for wiring or other devices. For example, as shown in FIG. 1, the deck end 106 extends at an oblique angle relative to the base end 108 (and a form on which the base end 108 may rest). Thus, for example, the entrance direction 114 as shown is obliquely angled relative to the exit direction 118 (e.g., with the exit direction 118 being substantially vertical). Accordingly, for example, the conduit 100 can generally provide a path through concrete at an angle of about forty-five degrees, e.g., for wiring received therethrough. Thus, in this and other similar configurations, the conduit 100 can provide a relatively low-profile structure to support and guide components through concrete (e.g., without protruding out of even relatively thin concrete decks).

To provide support relative to a concrete form, the base end 108 includes a base flange 120 that extends radially outward at the base end 108. Generally, a variety of other support components can be provided (e.g., multiple support legs, different base structures, etc.), and a variety of structures can be provided to secure the base end 108 to a form or other substrate. In the illustrated example, the base flange 120 has slots 122 that are open-ended in the lateral direction. The slots 122 can provide anchor points on the base flange 120 for fasteners (e.g., nails, not shown) to secure the conduit 100 to a form. Thus, the base flange 120 may be used to selectively secure the body 104 to a desired base location on a form for a concrete deck (not shown). As noted above, however, other support structures for a conduit body 104 can be used (e.g., closed fastener holes, etc.).

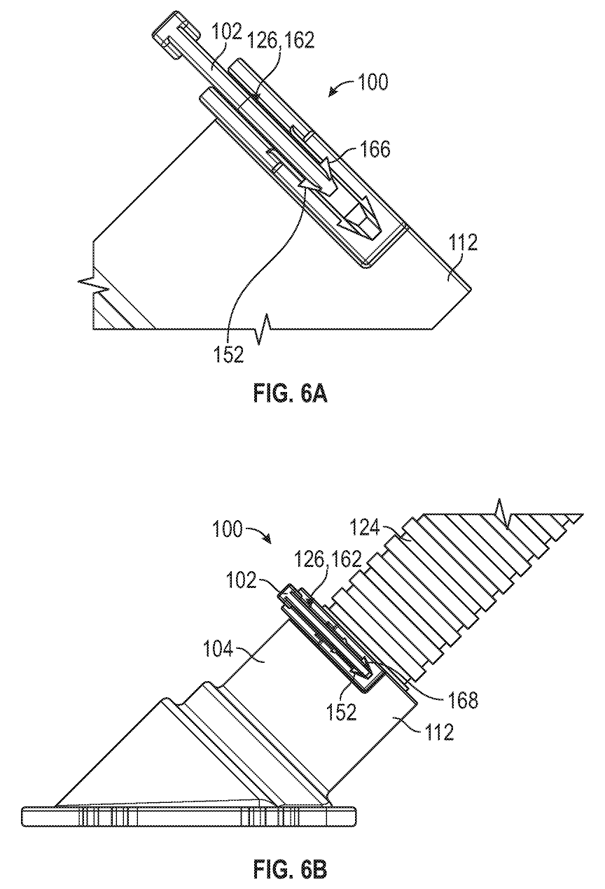

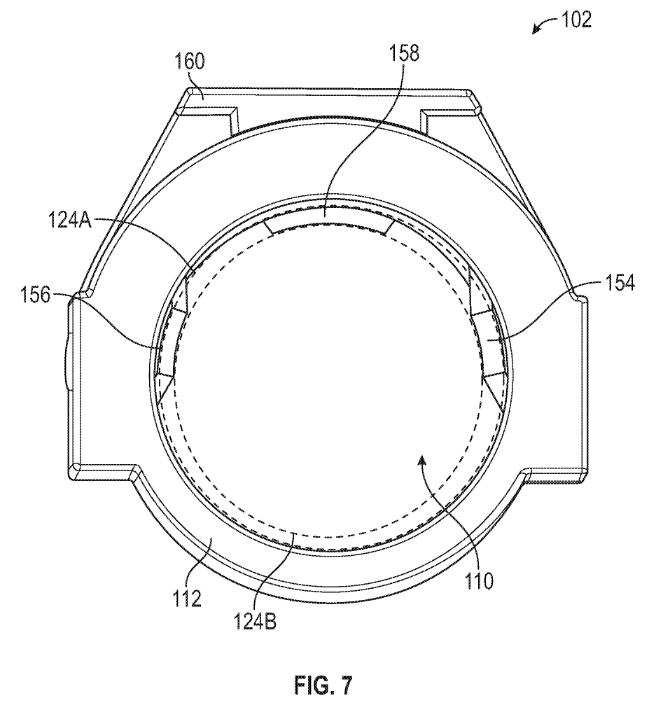

Referring still to FIGS. 1 through 3, the clip 102 is configured to be selectively attached to the conduit 100 so as to secure corrugate tubing 124 to the conduit 100 in a locked orientation (see also FIG. 6B). In particular, the conduit 100 includes an aperture that extends from outside of the body 104, through the body 104, to the internal passage 110. Thus, the clip 102 can be selectively advanced through the aperture to secure an object (e.g., corrugated tubing) within the conduit 100.

In the illustrated example, the aperture is provided as a continuous external circumferential opening, in particular as a locking slot 126. Further, as shown in FIGS. 1, 3, and 5, in particular, the locking slot 126 may extend into the internal passage 110 a plurality of discrete locations (e.g., to separately receive corresponding locking tabs on the clip 102). However, other configurations are possible.

Generally, the locking slot 126 (or other aperture) can be provided at the deck end 106, adjacent to the entrance 112, to effectively engage and lock the relevant object relative to the conduit 100. As will be further discussed below, in this way, the clip 102 enables adjustment and securement of the tubing 124 relative to the conduit 100 before concrete is poured.

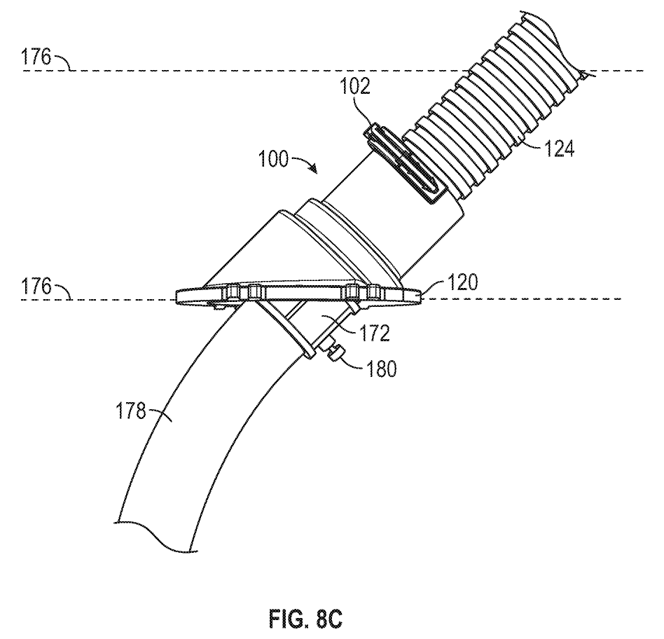

As shown in FIGS. 2 and 3, the conduit 100 has internal threads 128 formed within the internal passage 110 proximate the base end 108. As will be further discussed below, the internal threads 128 allow for different threaded attachments (e.g., a threaded coupler 172 in FIG. 8A) to be added to the conduit 100. In this way, the conduit 100 can be configured to easily engage other equipment (e.g., tubing), to direct wiring after the wiring passes through the conduit 100 (e.g., in a curved or angled direction, as further detailed below).

Referring in particular to FIG. 3, the entrance 112 of the conduit 100 is tapered. In particular, the internal passage 110 of the entrance 112 has a straight portion 130 and a tapered portion 132 that narrows the internal passage 110 inward along the entrance direction 114, relative to a reference cylinder 134 (e.g., with the straight portion 130 extending from the entrance 112 along the reference cylinder 134). The tapered portion 132 of the entrance 112 begins at a transition point 136 and extends toward a shoulder 138 of the conduit 100 located proximate and above the internal threads 128 (i.e., opposite the threads 128 from the base end 108). Thus, with the tapered portion 132 tapering inwardly, the internal passage 110 between the tapered portions 132 narrows along the entrance direction 114. In this way, tubing 124 inserted into the internal passage 110 can bear against the tapered portion 132 to be further fixed within the internal passage 110 when installed. This arrangement can also create a seal between the conduit 100 and the tubing 124 that can help to ensure that poured concrete does not enter the internal passage 110 (e.g., to block the passage 110, compromise the internal threads 128, etc.).

As noted above, the internal passage 110 has a shoulder 138 that protrudes inwardly relative to the internal passage 110. In particular, the shoulder 138 is positioned between the internal threads 128 and the tapered portions 132 of the entrance 112. In this way, for example, the shoulder 138 can provide a stopping point for the tubing 124, so that the tubing 124 does not extend past the shoulder 138 (e.g., towards the base end 108) when installed. Correspondingly, the shoulder 138 can also provide a stopping point for a threaded attachment (e.g., the threaded coupler 172) that is installed using the internal threads 128, so that the threaded attachments do not extend past the shoulder 138 (e.g., towards the deck end 106) when installed.

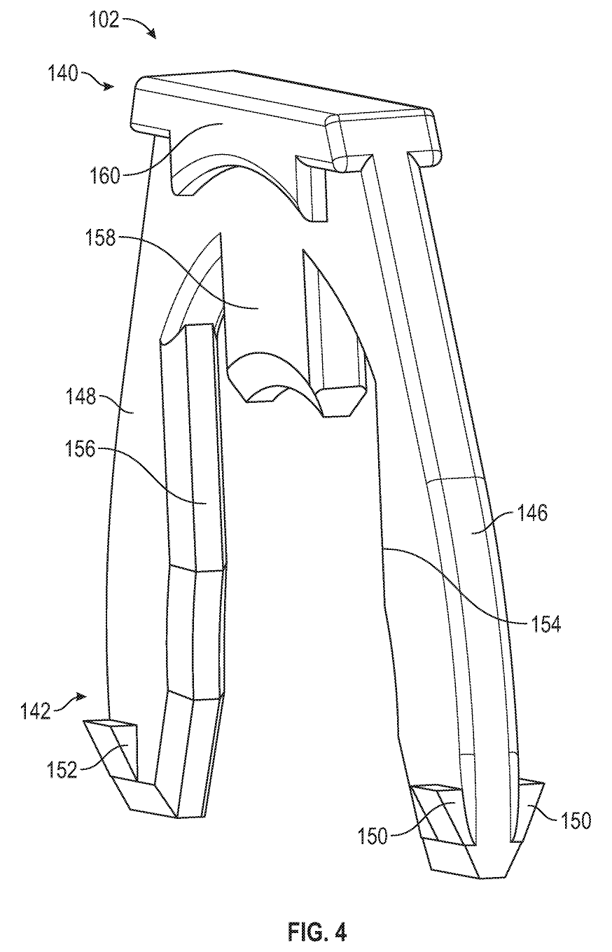

Turning now to FIG. 4, in an example configuration, the clip 102 has a first end 140 that is configured for manual engagement by a user to be moved into engagement with the conduit 100 (e.g., to provide tactile feedback once in a locked orientation). Correspondingly, the clip 102 also includes a second end 142 that is opposite the first end 140. The second end 142 extends to include one or more locking tabs that can extend through the locking slot 126 into the internal passage 110 to secure tubing. Further, the second end 142 can include features to secure the clip 102 in either of a staged orientation and a locked orientation, as will be further detailed below.

The clip 102 can be integrally formed (similarly to the conduit 100) and is generally U-shaped, with a right arm 146 and a left arm 148 that extend to the second end 142. The right arm 146 and the left arm 148 have corresponding arm tabs 150, 152, respectively. In the illustrated example, that clip tabs 150, 152 extend to both sides of the arms 146, 148 adjacent the second end 142. The tabs 150, 152 are configured to engage corresponding profiles within the locking slot 126 to secure the clip 102 in either the staged orientation or the locked orientation, as will be further discussed below. In other examples, the tabs 150, 152 can be replaced (or supplemented) with recesses on the arms 146, 148 that engage corresponding locking protrusions (not shown) within the locking slot 126. In this embodiment, the clip 102 is shown with two symmetrically arranged arms 146, 148 that cooperatively engage corresponding locking features of the locking slot 126, but other configurations are possible.

As further shown in FIG. 4, the right arm 146 and the left arm 148 also provide a right locking tab 154 and a left locking tab 156, respectively, that are configured to extend into the internal passage 110 to engage the tubing 124 when the clip 102 is in the locked orientation. A central locking tab 158 also (or alternatively) extends between the arms 146, 148 towards the second end 142. As will be further discussed below, the central locking tab 158 also can engage the tubing 124 in the locked orientation.

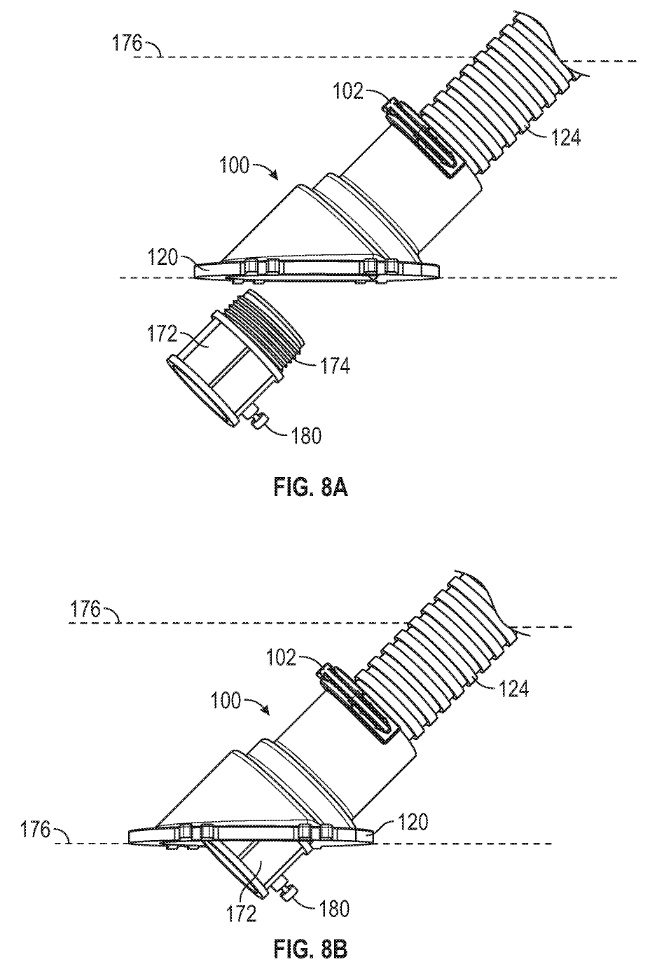

To facilitate manual engagement, a grip 160 can be positioned opposite the central locking tab 158, relative to the installation direction. The grip 160 can protrude proximate the first end 140 and can exhibit concave geometry, facing towards the second end 142. In the illustrated embodiment, the grip 160 is T-shaped, which can be a favorable profile for a user to grab and manipulate the clip 102. As shown in FIG. 7, for example, the grip 160 can seat against and protrude outside of the conduit 100 near the entrance 112, with the clip 102 in the locked orientation, to provide a relatively low profile overall.

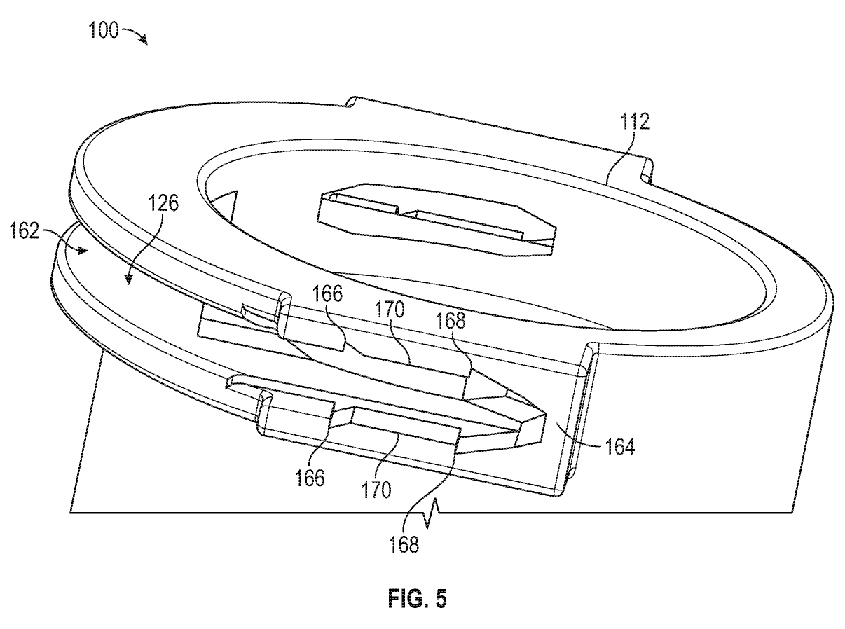

Referring now to FIG. 5, the locking slot 126 forms a clip passageway 162 that the clip 102 is inserted into. In the illustrated embodiment, the clip passageway 162 is configured as a cutout in a sidewall 164 near the entrance 112. As shown, the clip passageway 162 has first stage locks 166 configured as angled catches that extend off of the clip passageway 162. The first stage locks 166 are configured to receive the bottom tabs 150, 152 of the clip 102 in a first lock stage (e.g., a staged orientation, as will be further discussed below. The locking slot 126 also includes second stage locks 168 configured as angled catches that are positioned further along the locking slot 126 from the first stage locks 166, relative to the installation direction of the clip 102. The second stage locks 168 are configured to receive the bottom tabs 150, 152 of the clip 102 in a second lock stage (e.g., a locked orientation), as will be further discussed below. Also as further discussed below, the locks 166, 168 may in some cases include other geometry (e.g., protruding catches, rather than recessed catches)

As further shown in FIG. 5, a transition region 170 extends between the first stage lock 166 and the second stage lock 168 and is narrower in width as compared with the first stage lock 166 and the second stage lock 168. In this way, the transition region 170 provides some resistance to movement of the clip 102 during a change in position between the first stage lock 166 and the second stage lock 168.

The angled catch design of the first stage lock 166 and the second stage lock 168 are configured to correspond with the profile and size of the clip tabs 150, 152 of the clip 102. In this way, the first stage lock 166 and the second stage lock 168 are able to secure the clip 102 relative to the conduit 100 and prevent the clip 102 from being unintentionally removed from the clip passageway 162. In this embodiment, the conduit 100 is shown with two symmetrically arranged sets of the stage locks 166, 168 to cooperatively engaged the clip 102, but other configurations are possible (e.g., having just set of the locks 166, 168, multiple locking slots 126 configured to engage multiple clips, etc.).

FIG. 6A illustrates the clip 102 engaged in the first stage lock 166 in the staged orientation. For example, as shown, when the clip 102 is in the staged orientation, the clip tabs 150, 152 (see also FIG. 5) are secured within the first stage locks 166. In this embodiment, the central tab 158 and the arm tabs 154, 156 do not protrude to secure or block conduit (e.g., do not protrude within the internal passage 110). However, the clip 102 can be securely held in the staged orientation by the first stage lock 166 by the conduit 100 itself (e.g., rather than manually by an installed) until the relevant tubing is aligned to be secured. To reduce the number of overall components, in some examples, the clip 102 can be shipped in the staged orientation (i.e., installed in the first stage lock 166).

Turning now to FIG. 6B, the tubing 124 has been installed into the conduit 100 (e.g., with a seal against the tapered profile thereof, as discussed above). Further, the clip 102 has been advanced along the clip passageway 162 to the locked orientation, in which the clip tabs 150, 152 are engaged in the second stage lock 168. . Correspondingly, the right locking tab 154 and the left locking tab 156 of the clip 102 extend into the internal passage 110 (see FIG. 7) to engage the tubing 124. Further, in this example, the central tab 158 also extends into the internal passage 110 to engage the tubing 124, to further secure the tubing 124 relative to the conduit 100. In other words, as compared with the staged orientation of FIG. 6A, the clip 102 is advanced further within the clip passageway 162 to the second lock stage, so that the central tab 158, the left tab 156, and the right tab 154 block removal of the tubing 124. In this regard, for example, the tabs 154, 156, 158 may extend into the valleys of the exterior corrugating of the tubing 124, or may otherwise engage another relevant object received into the conduit 100.

To position the clip 102 in the locked orientation, a user can align the clip 102 with the clip passageway 162 as needed and advance the clip 102 towards the first stage lock 166 until the clip tabs 150, 152 are secured within the first stage lock 166. The user can then install tubing 124 within the internal passage 110 of the conduit 100. In an optional step, the user can advance the tubing 124 within the internal passage 110 so as to engage the tapered portion 132 of the internal passage 110 or position the tubing 124 onto the shoulder 138 that provides a leak-proof seal between the tubing 124 and the clip 102 (e.g., so concrete doesn’t enter the conduit 100 when poured, as discussed above). Once the tubing 124 is in the desired position, the user then advances the clip 102 towards the second stage locks 168 until the clip tabs 150, 152 are secured within the second stage lock 168. During advancement of the clip 102 towards the second stage locks 168, the clip tabs 150, 152 can be compressed within the transition region 170 of the clip 102 (e.g., by the force of advancement), such that the bottom tabs 150, 152 resiliently snap into the second stage locks 168 of the conduit 100. Further, as needed, a user may remove the clip 102 for further adjustment – e.g., by prying one of the arms 146, 148 laterally out engagement with the corresponding lock stage. Furthermore, before or after pouring the concrete, the user can install wiring through the tubing 124 and the conduit 100.

Referring still to FIG. 6B, the conduit 100 has a low profile so as to fit within shallow deck concrete. Furthermore, contours on the main body 104 (e.g., the tiered outer profile, as shown) help the conduit 100 to be retained within the concrete after the concrete is set and the form is removed. This design can facilitate a cleaner look, reduces labor (e.g., installation time), improves access to the wiring, and reduces the chance of corners or edges of the conduit 100 hindering pull through.

Turning now to FIG. 7, the clip 102 is shown in the locked orientation. As noted above, the locking tabs 154, 156, 158 of the clip 102 protrude into (e.g., and radially toward a center of) the internal passage 110 of the conduit 100. In particular, the right locking tab 154 and the left locking tab 156 of the clip 102 protrude into the internal passage 110 to engage the tubing 124 from opposing sides of the internal passage 110 and the tubing 124 (e.g., extending into a valley of a corrugation between a first outer diameter 124A and a second outer diameter 124B in ENT tubing). Similarly, the central locking tab 158 protrudes into the internal passage 110 to engage the tubing 124 at a different position than the right tab 154 and the left tab 156 (e.g., also into the corrugation in ENT tubing, between the locking tabs 154, 156). As further shown and as noted above, the grip 160 has a contour that extends along and engages the exterior of the conduit 100 at the entrance 112, in the locked orientation (e.g., to provide a stop against over-insertion, with corresponding tactile feedback for a user).

FIGS. 8A-8C illustrate an example installation with a threaded coupler 172. In particular, as noted above, the threaded coupler 172 has external threads 174 that engage with internal threads 128 of the conduit 100. In this embodiment, the clip 102 is in the locked orientation with the tubing 124 secured relative to the conduit 100. Furthermore, a concrete deck 176 is set and the form has been removed, leaving the conduit 100 embedded within the concrete deck 176. In this example, the threaded coupler 172 can receive wiring conduit 178 of various types, as needed (e.g., metal or plastic conduit secured with a set-screw 180, as shown in FIG. 8C). As shown in FIG. 8B, the threaded coupler 172 extends at a 45-degree angle relative to the base flange 120 and protrudes to the outside of the conduit 100 for improved access during installation, although other configurations are possible. When installed, the coupler 172 helps further avoid sharp internal bends or corners to facilitate an easier wire pull, as well as allowing improved overall flexibility in the components used (as noted above).

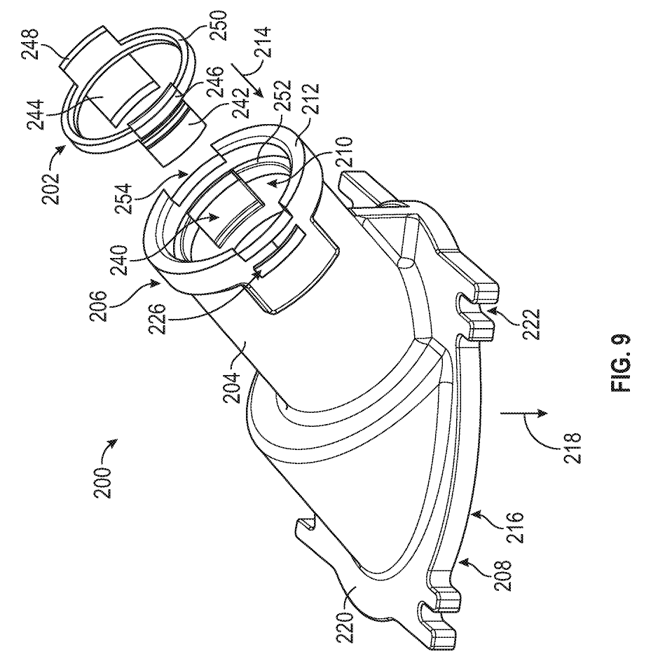

FIG. 9 shows a conduit 200 with a clip 202, as another configuration of the conduit 100 and the clip 102 to selectively secure corrugate tubing 124. As shown, the conduit 200 is generally similar to the conduit 100 and discussion above thus applies below unless otherwise indicated. For example, the conduit 200 correspondingly has a cylindrical body 204 with a deck end 206 and a base end 208. An internal passage 210 begins at an entrance 212 defining an entrance direction 214 and ends at an exit 216 defining an exit direction 218. The base end 208 has a base flange 220 with slots 222.

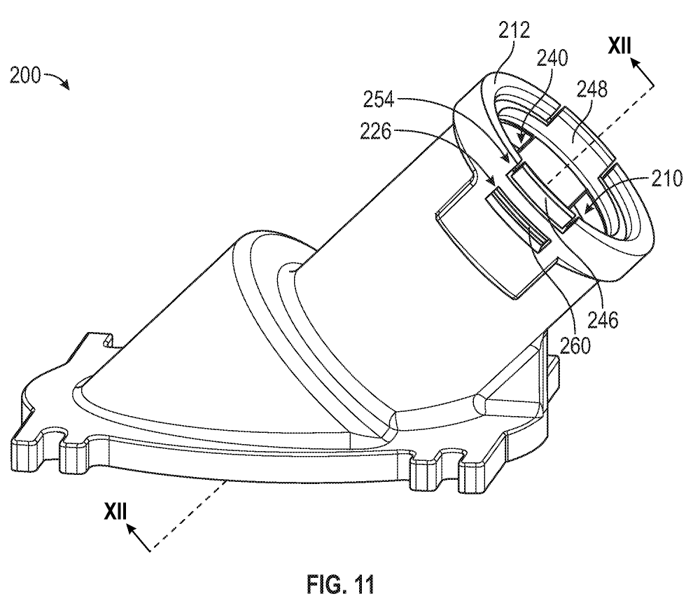

As shown in FIGS. 9 and 11, the clip 202 can be moved to be received and secured within the internal passage 210. In particular, the clip 202 can be secured by locking slots 226 of the conduit 200 (e.g., configured as first and second locking slots in this example), as further discussed below. With the clip 202 thus installed, the locking arms 242, 244 can help to secure corrugated tubing, as will be further detailed below.

Although not visible in FIG. 9, the conduit 200 can internally include threads, a straight portion, a tapered portion, a transition point, and a shoulder (e.g., as previously described for threads 128, the straight portion 130, the tapered portion 132, the transition point 136, and the shoulder 138 – see, e.g., FIG. 3).

As one example difference relative to the conduit 100, in the illustrated embodiment, the internal passage 210 of the conduit 200 defines pockets 240 that receive corresponding locking arms 242, 244 of the clip 202. The pockets 240 may be aligned with (e.g., include) the locking slots 226 and may extend axially along the internal passage 210 from the locking slots 226 toward the base end 208.

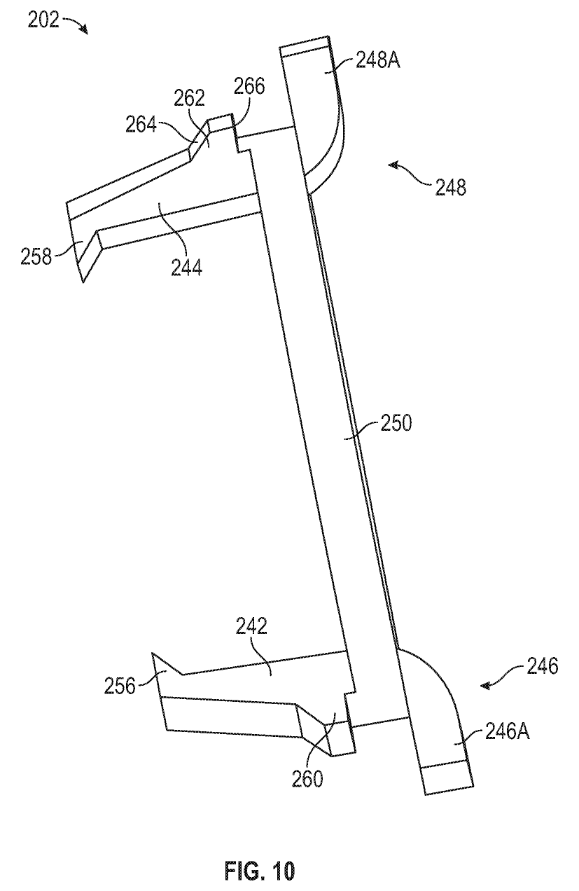

Referring to FIGS. 9 and 10, the clip 202 has a first grip 246 and a second grip 248 that are supported by and protrude outwardly away from a clip body 250. For example, the clip body 250 can be formed as a relatively thin annular structure, with the grips 246, 248 and the locking arms 242, 244 extending in opposite axial directions therefrom.

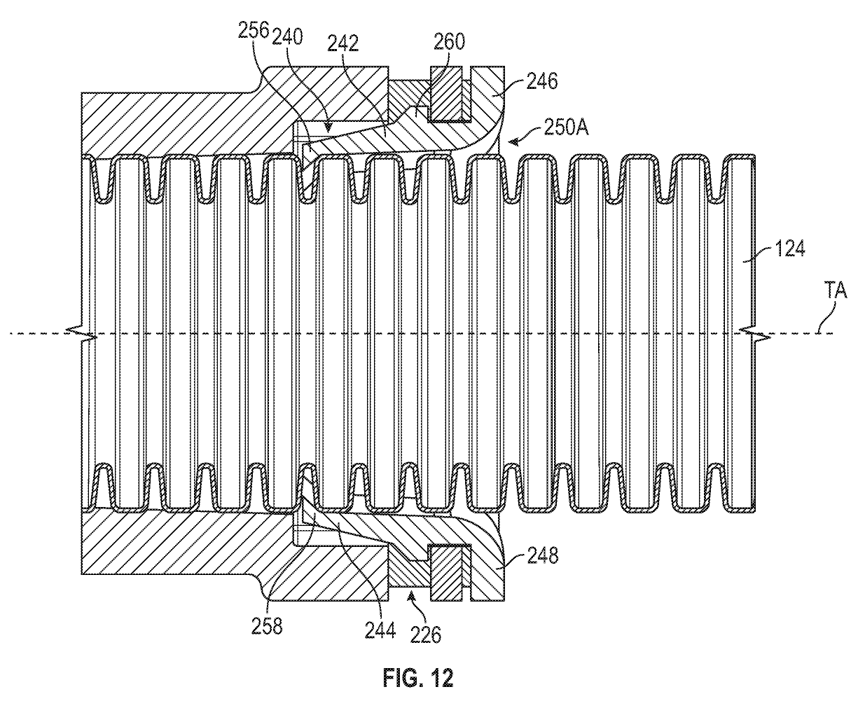

In general, the grips 246, 248 can be configured for manual engagement by a user, to apply a release force that facilitates disengagement of the clip 202 from the conduit 200. In the illustrated examples, the first and second grips 246, 248 include flange portions 246A, 248A that extend radially outwardly from the clip body 250 (e.g., as shown, substantially perpendicular to a tubing axis of tubing received through the clip body 250 (see, e.g., FIG. 12). In particular, in the example shown, the flange portions 246A, 248A can be engaged with compressive force to urge the flange portions 246A, 248A toward each other, resulting in a pivoting of locking arms 242, 244 (e.g., via flexing of the clip body 250).

In the example shown, the clip body 250 may define a central opening 250A configured to receive tubing 124. In general, the central opening 250A may be sized to permit the tubing 124 to pass therethrough and may be generally aligned with the internal passage 210 when the clip 202 is installed in the conduit body 204 (e.g., received into the internal passage 210, as further discussed below).

In some examples, as shown in FIG. 12, the tubing 124 can be received – and can extend along – a tubing axis TA. The tubing axis TA can extend axially through the tubing 124 and through the clip 202 and the conduit body 204 when the tubing 124 is installed. As illustrated, the tubing axis TA may serve as a reference frame for describing the structure of the clip 202 and the conduit body 204, as well as the tubing 124 itself (e.g., relative to axial movement within the conduit body 204). Directions extending at least partly toward the tubing axis TA may be referred to as radially inward directions (e.g., including directions substantially perpendicular to the tubing axis TA), and directions extending at least partly away from the tubing axis TA may be referred to as radially outward directions (e.g., including direction substantially parallel to the tubing axis TA).

As also noted above, to engage and secure the clip 202 with corrugated tubing, the clip 202 includes the locking arms 242, 244, which extend axially from the body 250 in a direction opposite the grips 246, 248. In the illustrated example, in particular, the arms 242, 244 are received (e.g., nested) within the pockets 240 to provide appropriate internal clearance for tubing.

To ensure the clip 202 is not inserted too far into the conduit 200, the conduit 200 has a ledge 252 that acts as a hard stop by abutting the body 250 of the clip 202 (e.g., when fully installed, as shown in FIG. 11). To ensure a lower overall profile of the clip 202 when installed on the conduit 200, the entrance 212 of the conduit 200 defines two notches 254 adjacent to the locking slots 226 that receive the grips 246, 248 (see also FIG. 11).

In this example, the clip 202 is installable in either of two rotational orientations. For example, the first locking arm 242 and the first grip 246 can be installed in either set of locking slot 226, pocket 240, and notch 254 of the conduit 200, as can the second locking arm 244 and the second grip 248. Correspondingly, the locking slots 226, locking arms 242, 244, grips 246, 248, and notches 254 are shown to be opposite to one another (e.g., spaced about 180 degrees apart), although other configurations with other spacing dimensions are possible. Furthermore, two locking slots 226, locking arms 242, 244, grips 246, 248, and notches 254 are illustrated, but more or fewer locking slots 226, locking arms 242, 244, grips 246, 248, and notches 254 are possible.

Turning now to FIG. 10, the clip 202 is shown in isolation. As noted above, the first and second grips 246, 248 protrude outwardly from the clip body 250 and the first and second locking arms 242, 244 extend from the clip body 250 in an axial direction opposite to the first and second grips 246, 248.

Further, the locking arms 242, 244 can include radially inward protrusions to engage corresponding corrugation(s) of tubing. In this embodiment, the locking arms 242, 244 have corresponding first and second fingers 256, 258 positioned on the arms 242, 244 distal from the clip body 250. As detailed below, and illustrated in FIG. 12 in particular, the fingers 256, 258 can engage the corrugate tubing 124 when installed.

In the example shown, the fingers 256, 258 are configured as protrusions that extend at an angle from the arms 242, 244 towards one another (relative to the tubing axis TA) and into the internal passage 210 to ensure engagement between the tubing 124 and the fingers 256, 258. In some examples, the fingers 256, 258 can extend towards the tubing axis TA at an angle between about 91 degrees and about 140 degrees, between about 95 degrees and about 130 degrees, or between about 100 degrees and about 120 degrees, although other configurations are possible.

Generally, the fingers 256, 258, the locking arms 242, 244, or other features of the clip 202 can be flexible, so that the fingers 256, 258 can be moved outwardly to release the tubing for axial movement (e.g., removal). Thus, for example, the locking arms 242, 244 can be deflected radially outwardly from an unflexed configuration to a wider flexed configuration – and can resiliently return therefrom – as desired (e.g., as a result of forces on the locking arms 242, 244 from insertion of corrugated tubing). In the embodiment shown, the locking arms 242, 244 angle inwardly towards one another in an unflexed configuration, from the tabs 260, 262 to the fingers 256, 258, so as to bias the fingers 256, 258 into engagement with the tubing 124, as further discussed below.

To retain the clip 202 within the conduit 200, the locking arms 242, 244 each have a locking tab 260, 262 extending radially outwardly from the arms 242, 244, respectively (e.g., disposed between the body 250 and the fingers 256, 258), and extending radially outwardly relative to the tubing axis TA. In particular, as shown in FIGS. 11 and 12, the locking tabs 260, 262 are received within the locking slots 226 of the conduit 200 in the installed configuration and can thus secure the clip 202 (and an associated tubing).

In the example shown, the tabs 260, 262 are beveled on a first side 264 and squared on an opposing second side 266 to enable a resilient response and snap-fit engagement when received within the locking slots 226. In general, the first side 264 of each locking tab 260, 262 may have a lesser angle relative to the axial direction of the locking arms 242, 244 to facilitate easy insertion into the locking slots 226, while the second side 266 may have a greater angle relative to the axial direction to provide strong retention within the locking slots 226. In some examples, the first side 264 of each locking tab 260, 262 extends at an angle of between about 5 degrees and about 85 degrees, or between about 15 degrees and about 60 degrees, or between about 15 degrees and about 45 degrees, although other configurations are possible. In some examples, the second side 266 of the locking tabs 260, 262 can extend at an angle between about 85 degrees and about 100 degrees, or between about 89 degrees and about 93 degrees, or between about 89 degrees and about 91 degrees, or about 90 degrees, although other configurations are possible.

When secured within the locking slots 226, the locking tabs 260, 262 may provide tactile feedback to a user indicating that the clip 202 has been properly installed within the conduit 200. For example, the squared second side 266 of each locking tab 260, 262 may form a shoulder that abuts a surface of the corresponding locking slot 226 to retain the clip 202 within the conduit body 204. The squared shoulder may thus help to prevent the clip 202 from being pulled axially out of the conduit body 204. In some examples, the locking tabs 260, 262 may be configured to contact the conduit body 204 at sides of the locking slots 226 to define pivot points about which the locking arms 242, 244 pivot when the grips 246, 248 are urged towards one another.

Referring now to FIG. 11, the clip 202 is shown in an installed configuration on the conduit 200. As illustrated, the clip 202 – and in particular, each of the arms 242, 244 – extends into the internal passage 210 and is received within the pockets 240 of the conduit 200 (see FIG. 9). Furthermore, the locking tabs 260, 262 of the clip 202 are secured within the locking slots 226 of the conduit 200 to retain the clip 202 in the installed position. Correspondingly, the grips 246, 248 are disposed within the notches 254 of the entrance 212 of the conduit 200.

In the illustrated example, the grips 246, 248 (or flange portions in some examples) are level with the entrance 212 of the conduit 200 (e.g., flush with an axial end of the conduit 200 at the entrance 212) to create an overall lower profile of the conduit 200. Such an arrangement can also help prevent inadvertent engagement of the grips 246, 248 such as might inadvertently release a secured tubing. In this embodiment, to install the clip 202 to the conduit 200, a user can align the grips 246, 248 with the corresponding notches 254 of the conduit 200 and advance the clip 202 into the internal passage 210 of the conduit 200 until the locking tabs 260, 262 are engaged within the locking slots 226.

After the clip 202 is secured within the conduit 200, for example, the corrugate tubing 124 can be installed. For example, the tubing 124 can be urged axially into the conduit 200, through the clip 202, so that the fingers 256, 258 engage a recessed exterior annulus of the tubing 124, at a desired depth (see, e.g., FIG. 12), to hold the tubing 124 against withdrawal in an opposite direction.

Turning now to FIG. 12, the tubing 124 is shown secured within the conduit 200. In particular, the fingers 256, 258 of the locking arms 242, 244 extend into a corresponding groove of the tubing 124 to retain the tubing 124 within the conduit 200. In the example shown, due to the taper of the locking arms 242, 244 as noted above, the fingers 256, 258 are biased into engagement with the corrugated surface of the tubing 124. In this way, the tubing 124 can be easily inserted within the internal passage 210 to a desired depth, with arms 242, 244 accordingly flexing to provide clearance at the fingers 256, 258 for passage of the tubing 124. Further, due to the biased engagement of the tubing 124 by the fingers 256, 258, the arms 242, 244 thus prevent the tubing 124 from slipping or being unintentionally removed from the conduit 200 (e.g., via a pulling force to the right in FIG. 12).

In order to remove or readjust the tubing 124, a user can apply an appropriate release force to the grips 246, 248 (e.g., a compressive force that urges the grips 246, 248 to pivot towards each other). Due to the resilient nature of the clip 202, this compressive (or other) force creates a counteracting force on the locking arms 242, 244 (e.g., via flexing of the clip body 250) that moves the arms 242, 244 – and thus the fingers 256, 258 – outwardly away from the tubing 124 (e.g., further into the pockets 240, away from the tubing axis TA). Thus, via engagement of the grips 246, 248 a user can disengage the fingers 256, 258 from the tubing 124, allowing the user to remove the tubing 124 or readjust the tubing 124 axially to a new position relative to the clip 202. Once the tubing 124 is in a desired position, a user can remove the release force from the grips 246, 248 so that the fingers 256, 258 resiliently return into engagement with the tubing 124 at the new position.

Accordingly, a user may be able to easily adjust or remove the tubing 124 within the passage 210, as desired. In some examples, removing or readjusting the tubing 124 relative to the conduit body 204 may include applying a compressive force to the grips 246, 248 and withdrawing the tubing 124 from the internal passage 210 while the compressive force is applied. In some examples, the method of readjusting or reapplying the tubing may include reinserting the tubing 124 into the internal passage 210 through the entrance 212 after withdrawing the tubing 124, or replacing the tubing 124 with a different tubing (not shown). In some examples, the clip 202 may be pre-installed in the conduit body 204 prior to installation of the tubing 124, such that a user installing the tubing 124 need not also install the clip 202.

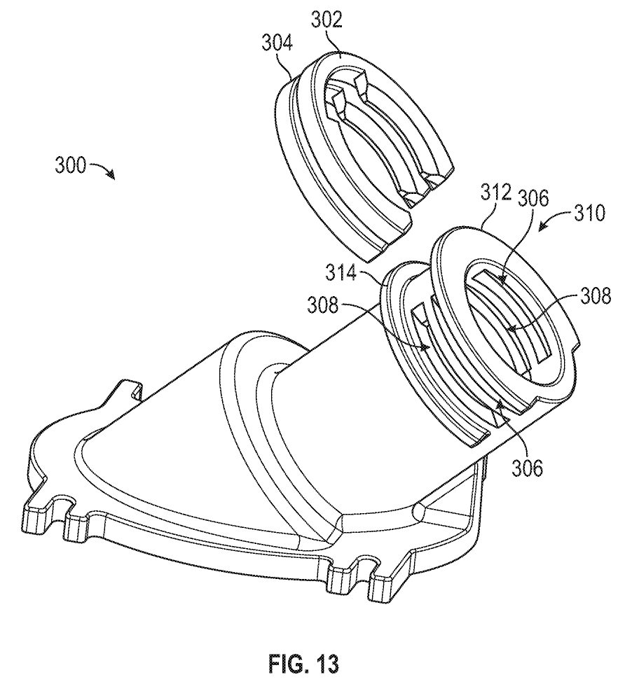

Referring now to FIG. 13, a conduit 300 is illustrated with a first clip 302 and a second clip 304, as another configuration of the conduit 100 and the clip 102 to selectively secure corrugate tubing 124. As shown, the conduit 300 is generally similar to the conduits 100, 200 having general corresponding features as discussed above in connection with the conduit 200. Discussion above thus applies below unless otherwise indicated.

As one example difference relative to the conduits 100, 200 in the illustrated embodiment, a first locking slot 306 and a second locking slot 308 are formed adjacent to a deck end 310 of the conduit 300. In this example, the locking slots 306, 308 are disposed between a first flange 312 and a second flange 314, respectively. Correspondingly, there are first and second clips 302, 304 that are secured within the first and second locking slots 306, 308 and between the first and second flanges 312, 314 when installed, as will be further detailed below. It will be appreciated that “first” here with regard to the first clip 302, the first locking slot 306, and the first flange 312 indicate each component being positioned closer to the deck end 310 of the conduit 300 when installed as compared with the second clip 304, second locking slot 308, and second flange 314, although other configurations are possible. In the illustrated example, the clips 302, 304 are substantially identical to each other, although other configurations are possible.

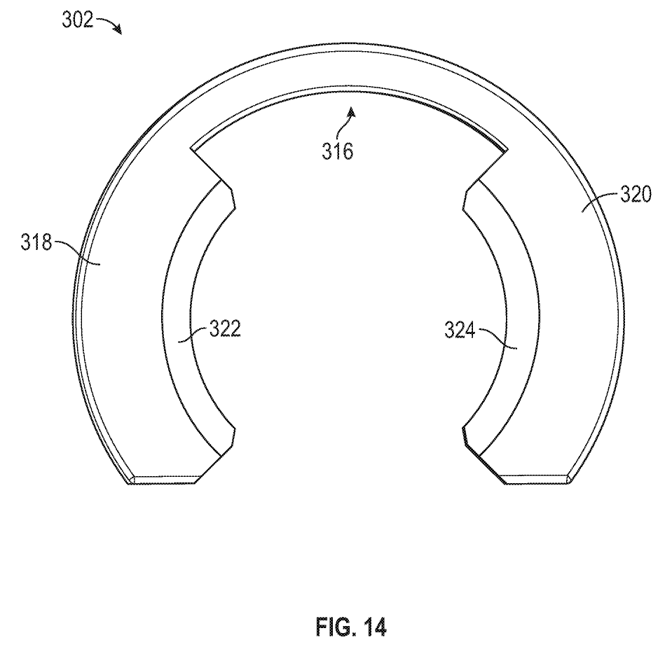

Referring now to FIG. 14, the first clip 302 is shown. As noted above, the clips 302, 304 are substantially identical in the illustrated example. Accordingly, even though the first clip 302 is shown, the second clip 304 shares the same corresponding features discussed below. In this example, the clips 302, 304 can be integrally formed (similarly to the conduit 300) and are generally U-shaped, with a central notch 316, a first arm 318 and a second arm 320 that have corresponding arm tabs 322, 324, respectively.

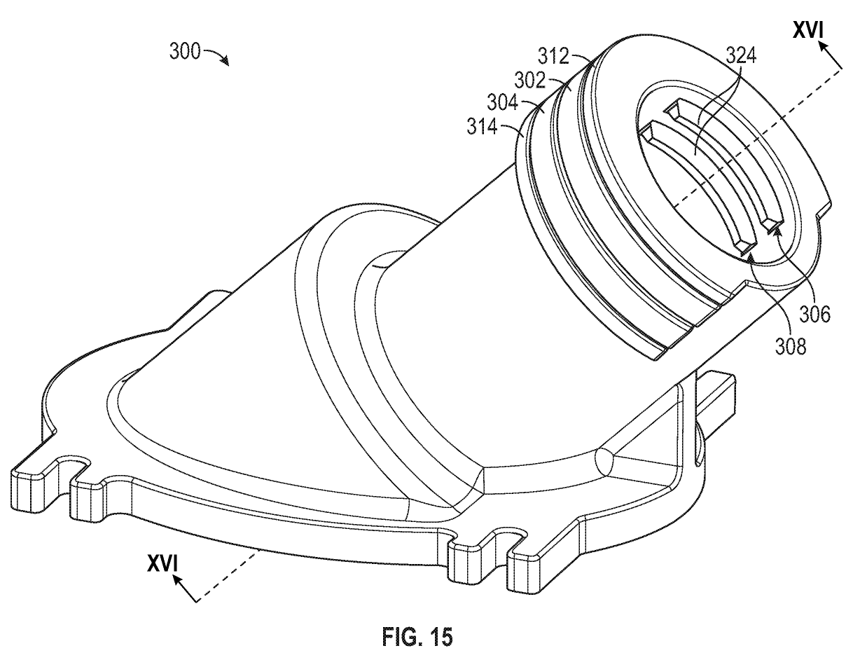

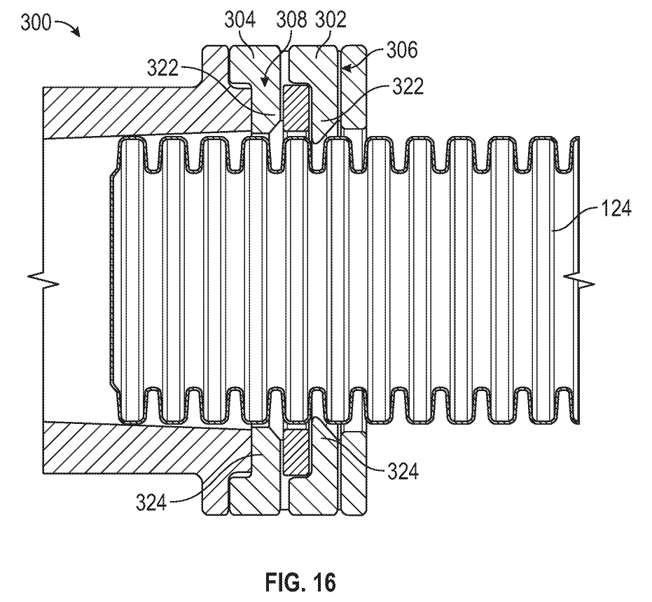

As shown in FIGS. 15 and 16, in particular, in the illustrated embodiment, the arm tabs 322, 324 extend into the internal passage (e.g., similar to internal passages 110, 210) of the conduit 300 to engage the tubing 124 when installed. In this example, the clip 302 is shown with two symmetrically arranged arms 318, 320 that cooperatively engage corresponding the grooves of the tubing 124 (see FIG. 16), but other configurations are possible. To facilitate manual engagement of the clip 302, a user can grasp and manipulate arms 318, 320 into (or out of) engagement with the locking slots 306, 308, as will be further detailed below.

As further shown in FIG. 14, the central notch 316 also (or alternatively) extends between the arms 318, 320. Accordingly, in this example, along the central notch 316 the clip 302 does not extend into the internal passage of the conduit 300 and instead abuts the outer surface of the body of the conduit 300 (e.g., similar to body 104, 204) when installed. Thus, for example, contact between the conduit 300 and the clips 302, 304 along the central notches 316 can provide a positive stop to ensure appropriate installation and alignment of the clips 302, 304.

Turning now to FIG. 15, the clips 302, 304 are shown in the installed configuration on the conduit 300. As illustrated, the clips 302, 304 are retained between (e.g., and flush with) the first flange 312 and the second flange 314, respectively, as noted above. In this example, the radially outer profiles first and second clips 302, 304 are level with the radially outer faces of the first and second flanges 312, 314, which creates an overall lower profile of the conduit 300.

To secure the tubing 124 (see FIG. 16), the locking tabs 324 of both clips 302, 304 extend into the internal passage so as to engage the tubing 124 when installed, as noted above. To install each clip 302, 304 onto the conduit 300, a user can manipulate the locking arms 318, 320 of each clip 302, 304 into engagement with the corresponding locking slots 306, 308. As noted above, once installed within the locking slots 306, 308, the movement of the locking arms 318, 320 into the slots 306, 308 may provide tactile feedback to a user indicating proper installment of the clip 302 onto the conduit 300, as well as help to ensure appropriate alignment of the clips 302, 304. In the illustrated example, the first and second clips 302, 304 can be installed together or separately, and in any order, although other configurations are possible (e.g., with the clips 302, 304 formed as a single body and thus installable simultaneously).

Once the clips 302, 304 are installed onto the conduit 300, for example, a user can then install the corrugate tubing 124 by urging the tubing 124 axially into the conduit 300, past the locking arms 318, 320. In this regard, FIG. 16 illustrates a cross-sectional view of the tubing 124 when installed within the conduit 300. In this embodiment, to install the tubing 124 within the conduit 300, the arms 318, 320 of the clips 302, 304 operate as leaf springs that flex outwardly from the inner passage as the tubing 124 is installed and then resiliently snap back into engagement with the tubing 124.

In particular, the arms 318, 320 of the first clip 302 can be axially spaced from the arms 318, 320 of the second clip 304 to help ensure secure engagement regardless of insertion depth of the tubing 124. For example, in particular, as illustrated, the tabs 322, 324 of the first clip 302 are spaced axially from the tabs 322, 324 of the second clip 304 by a different spacing than the pitch of the corrugations of the tubing 124 (e.g., by approximately 1.5 times the spacing between ribs of the corrugation of the tubing 124). Accordingly, as shown in the installed example, the tabs 322, 324 of the first clip 302 are engaged with a groove of the tubing 124, while the tabs 322, 324 of the second clip 304 are not. Further, additional axial movement of the tubing 124 that misaligns the first clip 302 with a groove of the corrugation may correspondingly result in alignment of the second clip 304 with a different groove of the corrugation, to ensure continued secure engagement. In this way, at least one of the first clip 302 or the second clip 304 can retain the tubing 124 within the conduit 300, regardless of the position of the tubing 124. However, other configurations are possible, including with both clips 302, 304 engaging corresponding grooves of the tubing 124.

Thus, in the illustrated embodiment, the two clips 302, 304 help ensure that the tubing 124 will be engaged and secured with at least one of the clips 302, 304 when installed. In particular, this dual locking system provided with the clips 302, 304 can be beneficial for larger tubing 124 with a greater spacing between the ribs. Accordingly, a variety of large corrugate tubing 124 can be installed within the conduit 300 using the same clips 302, 304, which minimizes the number of components needed.

To remove or readjust the tubing 124 within the conduit 300, a user can manipulate the arms 318, 320 of either clip 302, 304 and remove them from the locking slots 306, 308. For example, a user can manually pry one of the arms 318, 320 free of the corresponding slot 306, 308 and release the corresponding clip 302, 304 from engagement with the body of the conduit 300 (e.g., to be fully removed therefrom).

Thus, embodiments of the disclosure can provide improved conduits for passage of wiring or other components through concrete. For example, a clip can be selectively coupled with the conduit so as to engage and secure tubing when installed. As another example, the in-deck conduit may provide an easier wire pull through such that there are no sharp corners or edges.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

For convenience of presentation, in some figures that include multiple instances of similar features (e.g., multiple ribs, struts, or parts of a grating), only some of the similar features may be specifically indicated by reference number. One of skill in the art will recognize that the features not labeled with reference numbers can include similar aspects and perform similar functions to similar features that are labeled with reference numbers. Similarly, some features may be labeled with reference numbers in only select figures.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Also as used herein, unless otherwise limited or defined, “integral” and derivatives thereof (e.g., “integrally”) describe elements that are manufactured as a single piece without fasteners, adhesive, or the like to secure separate components together. For example, an element that is stamped, cast, or otherwise molded as a single-piece component from a single piece of sheet metal or other continuous single piece of material, without rivets, screws, other fasteners, or adhesive to hold separately formed pieces together, is an integral (and integrally formed) element. In contrast, an element formed from multiple pieces that are separately formed initially then later fastened together, is not an integral (or integrally formed) element.

Unless otherwise specified or limited, the terms “about” and “approximately,” as used herein with respect to a reference value, refer to variations from the reference value of ± 20% or less (e.g., ± 15, ± 10%, ± 5%, etc.), inclusive of the endpoints of the range. Similarly, as used herein with respect to a reference value, the term “substantially equal ” (and the like) refers to variations from the reference value of ± 5% or less (e.g., ± 2%, ± 1%, ± 0.5%) inclusive. Where specified in particular, “substantially” can indicate a variation in one numerical direction relative to a reference value. In particular, the term “substantially less” than a reference value (and the like) indicates a value that is reduced from the reference value by 30% or more (e.g., 35%, 40%, 50%, 65%, 80%), and the term “substantially more” than a reference value (and the like) indicates a value that is increased from the reference value by 30% or more (e.g., 35%, 40%, 50%, 65%, 80%).

Also as used herein, unless otherwise specified or limited, “substantially parallel” indicates a direction that is within ± 12 degrees of a reference direction (e.g., within ± 6 degrees or ± 3 degrees), inclusive. Correspondingly, “substantially vertical” indicates a direction that is substantially parallel to the vertical direction, as defined relative to the reference system (e.g., for a building, relative to a plumb vertical line as can generally correspond to the direction of in-wall studs), with a similarly derived meaning for “substantially horizontal” (relative to the horizontal direction, as can generally correspond to the direction that spaces adjacent in-wall studs apart from each other).

As used herein, unless otherwise limited or specified, “substantially identical” refers to two or more components or systems that are manufactured according to the same process and specification, with variation between the components or systems that are within the limitations of acceptable tolerances for the relevant process or specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A conduit system for passing through concrete sections, the conduit system comprising:
a conduit body defining an internal passage extending from an entrance at a deck end of the conduit body to an exit at a base end of the conduit body, the base end including a mounting flange configured to secure the conduit body to a concrete form;
a first locking slot and a second locking slot formed in the conduit body adjacent the deck end, the first and second locking slots extending from an exterior surface of the conduit body to the internal passage; and
a clip received into the conduit body, with the clip including:
a clip body including a central opening configured to receive tubing along a tubing axis;
a first grip and a second grip extending in a first axial direction from the clip body; and
a first locking arm and a second locking arm extending from the clip body in a second axial direction opposite the first axial direction, each of the first and second locking arms extending into the internal passage and having:
a locking tab extending outwardly relative to the tubing axis and being received within the first or second locking slot to retain the clip relative to the conduit body; and
a finger extending inwardly relative to the tubing axis to engage the tubing within the internal passage,
the first and second grips each extending outwardly relative to the tubing axis, to be movable relative to the clip body to move the first and second locking arms and thereby move the fingers outwardly relative to the tubing axis to release the tubing for movement along the tubing axis.

2. The conduit system of claim 1, wherein the deck end of the conduit body defines pockets along the internal passage that receive the first and second locking arms of the clip.

3. The conduit system of claim 2, wherein, with the first and second locking arms in a flexed configuration, the fingers are received within the pockets to provide clearance for movement of the tubing along the tubing axis within the internal passage.

4. The conduit system of claim 1, wherein, in an unflexed configuration, the first and second locking arms angle towards one another, from the clip body to the fingers, to provide biased engagement of the fingers with the tubing.

5. The conduit system of claim 1, wherein the tubing is corrugated tubing, and wherein the fingers extend into corresponding grooves of the corrugated tubing to retain the corrugated tubing within the conduit body.

6. The conduit system of claim 1, wherein the conduit body includes an internal ledge that abuts the clip body to provide a stop against over-insertion of the clip along the tubing axis.

7. The conduit system of claim 1, wherein each of the first and second grips includes a flange portion that extends radially outwardly away from clip body.

8. The conduit system of claim 7, wherein the deck end of the conduit body defines notches that receive the flange portions of the first and second grips.

9. The conduit system of claim 8, wherein the flange portions are recessed into the notches to be flush with the conduit body at the entrance of the internal passage.

10. The conduit system of claim 1, wherein the internal passage extends in an insertion direction from the entrance toward the exit, the entrance including a tapered portion that narrows along the insertion direction.

11. A conduit system for passing through concrete sections, the conduit system comprising:
a conduit body having a deck end and a base end configured to be secured to a concrete form, the conduit body defining an internal passage that extends from an entrance at the deck end to an exit at the base end; and
a clip that is receivable into the deck end to secure corrugated tubing within the conduit body, the clip including:
a clip body configured to surround the corrugated tubing;
locking arms extending axially from the clip body and including:
locking tabs extending outwardly to retain the clip within the conduit body; and
fingers located distal from the clip body, the fingers forming protrusions that extend radially inwardly to engage corrugated tubing received within the conduit body; and
grips extending axially from the clip body in an opposite direction from the locking arms, the grips protruding radially outwardly from the clip body and being configured to be urged towards one another to move the fingers apart from each other, to release the corrugated tubing from the conduit body.

12. The conduit system of claim 11, wherein the locking tabs are beveled on a first side and squared on an opposing second side.

13. The conduit system of claim 12, wherein the squared second side of the locking tabs forms a shoulder that abuts a surface of a corresponding locking slot of the conduit body to retain the clip within the conduit body.

14. The conduit system of claim 11, wherein the conduit body includes locking slots that receive the locking tabs; and
wherein the locking tabs are configured to contact the conduit body at sides of the locking slots to define pivot points, about which locking arms pivot to move the fingers apart from each other, when the grips are urged towards one another.

15. The conduit system of claim 11, wherein the conduit body includes pockets along the internal passage; and
wherein, with the clip received into the deck end, the locking arms are aligned to pivot into the pockets in response to the grips being urged towards one another, to move the fingers away from the corrugated tubing.

16. The conduit system of claim 11, wherein the locking arms angle inwardly towards one another, from the locking tabs to the fingers, to bias the fingers into engagement with the corrugated tubing.

17. A method of installing tubing in a conduit system, comprising:
providing a conduit body having an internal passage that extends from an entrance at a deck end to an exit at a base end, the conduit body having locking slots formed adjacent the deck end, and the internal passage receiving a clip, with locking arms of the clip extending from a clip body along the internal passage, locking tabs on the locking arms engaging the locking slots, fingers on the locking arms extending inwardly into the internal passage, and first and second grips of the clip protruding outwardly from the clip body;
inserting tubing into the internal passage through the entrance, so that the fingers resiliently engage an exterior surface of the tubing to retain the tubing within the conduit body; and
adjusting a position of the tubing within the internal passage by:
applying force to the first and second grips to move the fingers away from the tubing;
moving the tubing axially to a new position relative to the clip; and
after moving the tubing to the new position, releasing the force from the first and second grips so that the fingers are resiliently returned into engagement with the tubing to retain the tubing at the new position.

18. The method of claim 17, further comprising:
removing the tubing from the conduit body by:
applying the force as a compressive force to the first and second grips; and
withdrawing the tubing from the internal passage while the compressive force is being applied.

19. The method of claim 18, further comprising reinserting the tubing into the internal passage through the entrance after withdrawing the tubing.

20. The method of claim 18, further comprising replacing the tubing with a different tubing after withdrawing the tubing.
